(19) United States
(12) Patent Application Publication
(10) Pub. No.: US 2013/0005417 A1
(43) Pub. Date: Jan. 3, 2013

(54) MOBILE DEVICE ACTION GAMING

(76) Inventors: Peter Schmidt, Miami, FL (US); John Fanning, Hull, MA (US); John Fanning, JR., Hull, MA (US)

(21) Appl. No.: 13/537,584

(22) Filed: Jun. 29, 2012

Related U.S. Application Data
(60) Provisional application No. 61/502,943, filed on Jun. 30, 2011.

(51) Int. Cl. A63F 13/06

(52) U.S. Cl. 463/5; 463/8

(57) ABSTRACT

A method includes, at a server, comparing (a) a geographic position of a mobile wireless device held by a person who is a target in a game with (b) an indication of a targeted position related to the target as shown on a mobile wireless device being held by a person who is an attacker in the game. The method further includes, depending on a result of the comparing of the geographic position and the indication, recording that the attacker has hit the target in the game.

### RELATED APPLICATION

This application claims priority to U.S. provisional application Ser. No. 61/502,943, filed on Jan. 30, 2011, the contents of which are incorporated herein by reference.

### BACKGROUND

This description relates to mobile device action gaming.

### SUMMARY

In general, in an aspect, at a server, a comparison is made of (a) a geographic position of a mobile wireless device held by a person who is a target in a game with (b) an indication of a targeted position related to the target as shown on a handheld device being held by a person who is a attacker in the game. Depending on a result of the comparing of the geographic position and the indication, recording that the attacker has hit the target in the game.

Implementations may include one or more of the following features. The indication includes a reticle. The geographic position is provided to the server wirelessly. The indication is provided to the server wirelessly. The attacker and the target are members of different teams. Recording that the attacker has hit the target includes designating that the target has been captured by the attacker. Designating that the target is been captured by the attacker includes designating that the target has become a member of the attacker's team. After being captured by the attacker, the target is enabled to escape. Enabling the target to escape includes providing an interactive feature of the mobile wireless device of the target. The interactive feature includes designating an area on a display of the target's mobile wireless device that is be touched repeatedly. The target is deemed to have escaped if the target touches the designated area of the target's mobile wireless device enough times within a specified timeframe. Each of the people and other people can buy virtual items for use in the game. The virtual items include weapons, ammunition, and armor.

In general, in an aspect, at a server, determining, from an image captured by a camera of a mobile wireless device of surroundings of the mobile wireless device, whether a target of an attacker who is holding the mobile wireless device is present in the image. If so, the mobile wireless device held by the attacker is notified.

Implementations may include one or more of the following features. The determining includes image recognition of the image and a comparison of the recognized image to a known image of the target. The image recognition includes facial recognition. The image recognition includes object recognition. The determining is done at the mobile wireless device.

In general, in an aspect, at a server, constructing a three-dimensional representation of a battlefield of a game, based on an image captured by a camera of a mobile wireless device of surroundings of the mobile wireless device.

Implementations may include one or more of the following features. Constructing a three-dimensional representation of a battlefield of a game is also based on images captured by the cameras of multiple handheld devices of surroundings of the handheld devices. The geographic position and the targeted position are displayed on a map that is served to the mobile wireless device. The map includes a street map provided by a third party. On the device of at least one of the people, indications are displayed of the locations of other players. The displaying includes displaying only friendly players or only enemy players. The map includes a map of a battlefield.

In general, in an aspect, information is provided from a server wirelessly to mobile wireless devices being used in an action game by players belonging to a team for presentation to the respective players on displays of the devices. The presentations to each of the different players are configured specially for that player. The information that is provided to a particular one of the mobile wireless devices is configured for presentation to one of the players of a composite of the presentations to the other players of the team.

Implementations may include one or more of the following features. One of the players is serving as a commander of the team and the presentation is in a commander mode on the mobile wireless device of that player. The attacker is enabled to use virtual artillery as a weapon on making the hit. The server determines trajectories of shots fired from the virtual artillery. The target can use virtual armor to resist an attack by the attacker. The server maintains a global scoreboard for scores achieved by players and teams in the game. A participant in the game can buy upgrades. In-game advertising can be displayed to participants in the game. Performance of players in the game can be shown on social-network online sites. Experience points can be attributed to the attacker, the experience points being based at least in part on an experience level of the target. A training mode is enabled in which no scores are kept. On the server rankings are maintained for players, and players are advanced in rank based on their performances. A player or team can conquer a territory by hitting or excluding players of other teams from the territory.

The server manages the game so that a target that has more game experience than an attacker is harder for the attacker to hit and can escape more easily. The server manages the game so that the more experience points a target has, the more experience points an attacker receives for a successful hit. A voice or text private communication channel is provided between players. A player can instruct another player through the communication channel. Recording of the hit comprises recording the hit if the geographic position and the indication are close enough to a shot's path to be a hit. The target is verified to be present based on location information on the server. The participants in the game wear a visible token that identifies them or a team to which they belong. Direct communication between the mobile wireless devices is enabled, using wireless networking, ad-hoc networks on 802.11a/b/g/n, or bluetooth. The direct communication supplements, extends, or heals a main communication channel. Participants in the game are enabled to indicate a target by choosing a location on a map and hitting it with a shot that takes an interval of time to strike and affects a defined region of the target, thus simulating indirect fire with an explosive. A player in the game is enabled to buy, as part of the game, virtual versions of ransom, intelligence, medical insurance, or medical treatment.

These and other aspects, features, and implementations, and combinations of them, can be expressed as methods, systems, apparatus, means and steps for performing functions, business methods, program products, and in other ways.

Other features and advantages of the invention will be apparent from the description and from the claims.

### DESCRIPTION

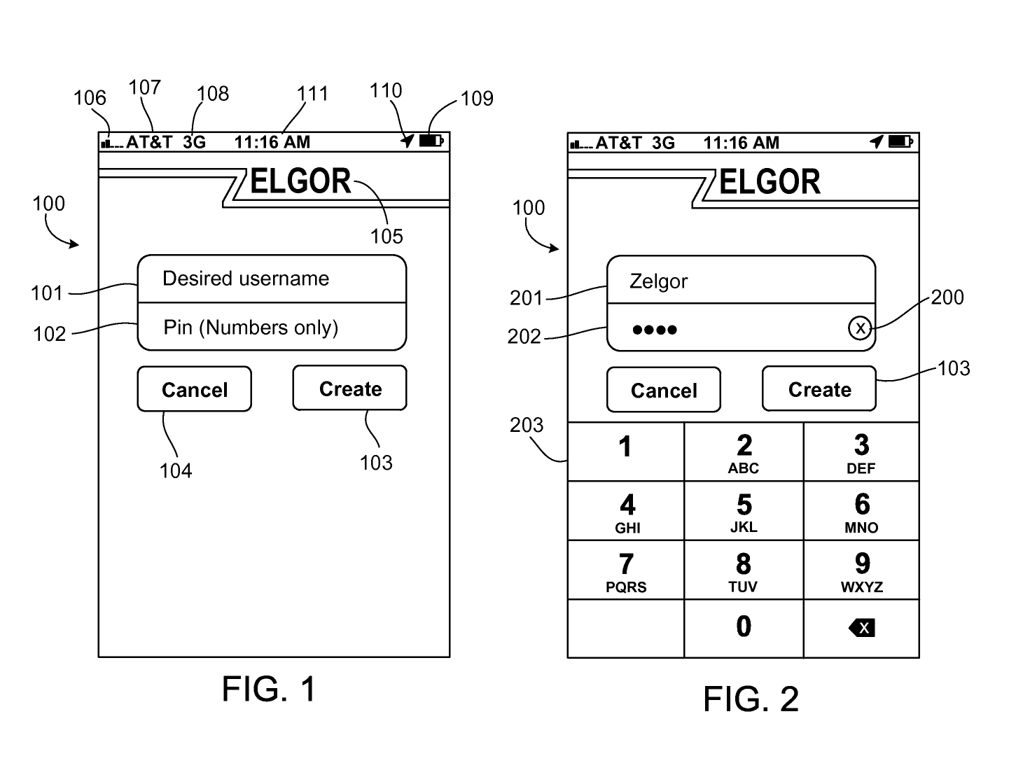

FIGS. 1-21 are screenshots.

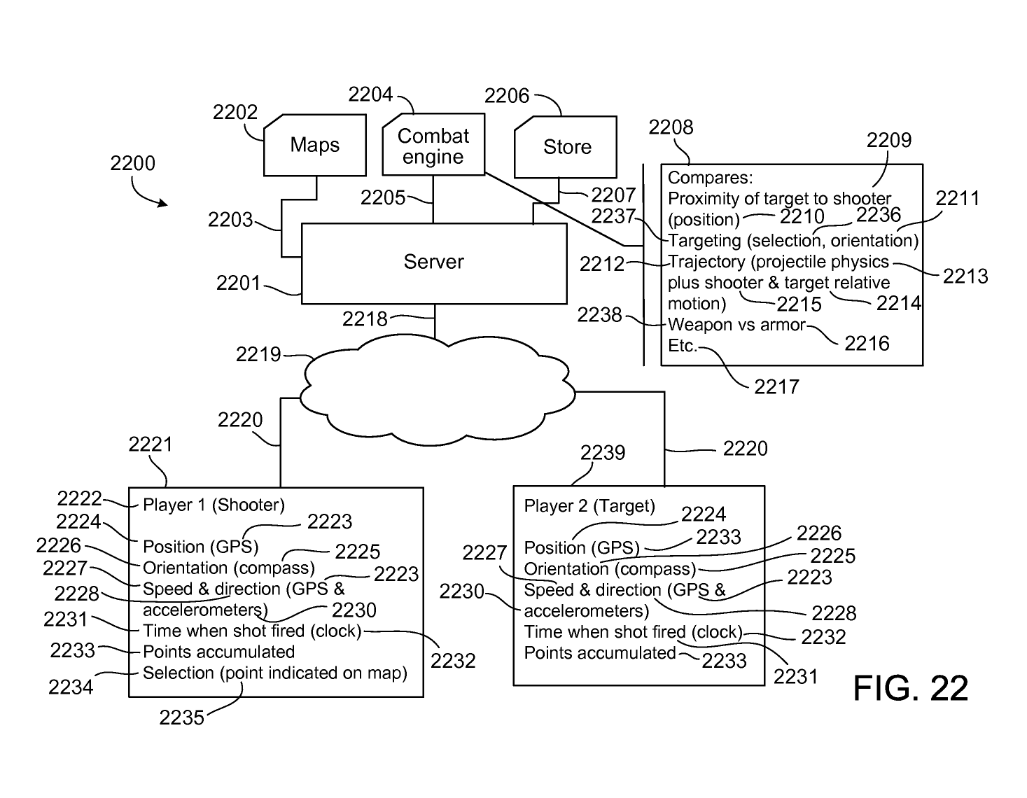

FIG. 22 is a block diagram of an example architecture of the game system.

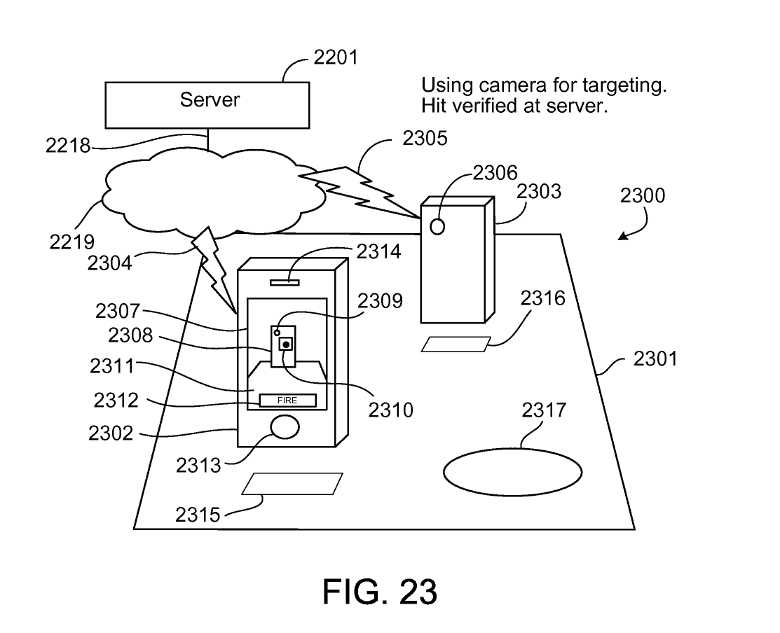

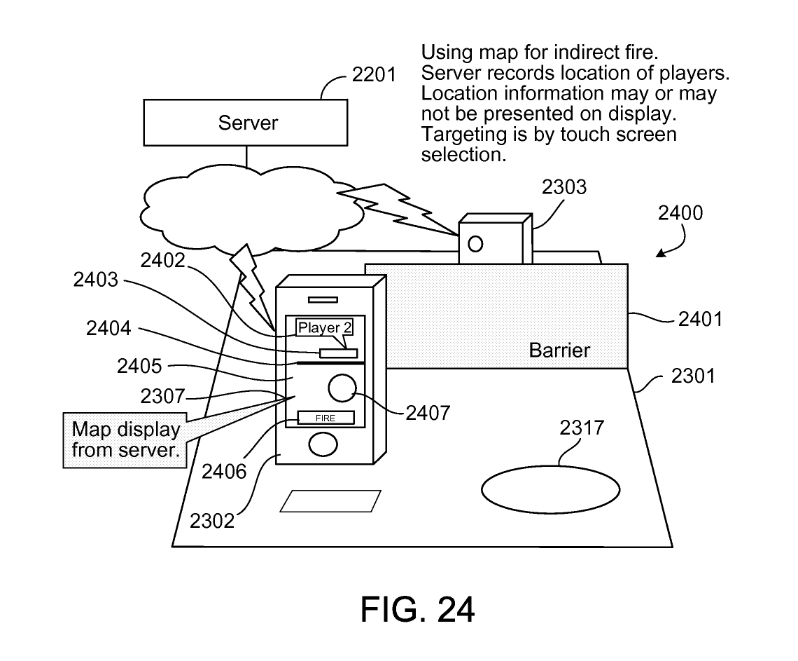

FIGS. 23-24 illustrate examples of the how the mobile wireless devices are used to play the game.

Here, we describe a game that can be played by two or more players using their handheld devices such as iPhones or other phones, or other mobile wireless devices. In some respects the game resembles laser tag. The players are ranked globally based on their success in playing the game. Their scoring achievements in the game can be posted on a social networking site such as Facebook.

In some examples, each player of the game is a member of a single team at a given time and is trying to hit (in a virtual non-physical sense using a virtual non-physical weapon) members of other teams, through the medium of her mobile wireless device. Players use their mobile wireless devices to locate, target, and shoot at other players on a virtual battlefield. Players have a variety of weapons to choose from, including guns and artillery. Players also have a variety of armor to choose from, which decreases a player's chance of being hit by an opponent.

The object of the game is to hit members of other teams and in that way to score points. Because accuracy in shooting is tracked, a player is encouraged to have a high hit-to-miss ratio for shots.

When ready to play the game, a player starts the mobile wireless device game application (for example, by invoking an icon displayed on the mobile wireless device) and logs into a game account maintained for the player on the server. If the player does not have a game account, one can be created through the game application.

Once logged into the player's account on the server, the player is shown the battlefield. In some implementations, the displayed battlefield is a map of the player's real world surrounding area that is continually updated with the player's real world location along with the real world location of any enemies (on other teams) and allies (on the player's team). The map can be an actual map of the area from a provider such as Google. In some implementations, the server can construct a three-dimensional representation of the battlefield based on input from the players' mobile wireless devices and transmit the representation to the players' mobile wireless devices. The server can use information from the mobile wireless devices' cameras, GPSs, accelerometers, and compasses to construct the battlefield.

In addition to the battlefield, the server causes a display on a player's mobile wireless device of game-style representations of the player and of other players. When a player sees a game-style representation of an enemy on the player's mobile wireless device who the player wants to attack, the player touches the game-style representation of the enemy on the player's mobile wireless device screen. An attack panel is displayed along the bottom half of the map. The player can choose a weapon and ammunition on the attack panel. Once a weapon and ammunition are chosen, the map display could show if the enemy is in range of the weapon. If the enemy is out of range, the player could either move closer to the enemy until the enemy is in range, or wait until the enemy moves into range. Once in range, the player could be shown a targeting reticle on the enemy on the mobile wireless device screen. As the player or enemy moves, the reticle could automatically move to remain on top of the enemy. If the player decides not to attack, the player can press the cancel button to remove the attack screen. If the player wants to attack, the player touches the attack button.

The server will determine whether a shot was successful based on a number of factors including the players' distance and relative motion, the shooter's orientation, the shooter's weapon and ammunition used, and the presence of enemy armor (all of which can be known to the server). If the server determines that the hit was successful, the server will also record a successful attack in the global rankings for the player, the enemy's mobile wireless device will vibrate indicating a hit, and the shooter's mobile wireless device will display a successful attack message. If the player misses, the server will record a miss for that player, and the player's mobile wireless device will display a missed message. If the hit was successful, the enemy is the to be captured and is now on the player's team. The enemy can attempt to escape by rapidly pressing a button on the enemy's mobile wireless device screen. If the escape is successful, the enemy is returned to the enemy's prior team, and a message is shown on both players' mobile wireless device reporting the result. If the escape is unsuccessful, the enemy remains captured.

The game relies on a server to centralize data storage and computation, and to keep the computational burden low on the mobile wireless devices to enable a more responsive game experience for the players. Processing by the game server includes, but is not limited to, tracking the location of players, determining if an enemy is in proximity to a shot, facial recognition of players, object recognition—including target objects and locations, construction of a three-dimensional representation of the game battlefield based on, among other things, the mobile wireless devices' camera input, tracking and awarding experience points to players for successful completion of objectives such as capturing an enemy player. Because the server tracks the location, orientation, and movement of the players' handheld devices, and updates the players' mobile wireless devices' screens based on the tracked information, mobile wireless mobile wireless device the server can maintain a common frame of reference on behalf of the mobile wireless devices.

The server maintains a global scoreboard on which players' achievements are tracked, such as number of successful hits on enemies, accuracy of shots, and number of times a player has been captured. The server also maintains experience points for each player, which are awarded to a player based on the experience points of a captured enemy player. The more experience a captured enemy player has, the more experience points the server awards to the capturing player. These scores can be displayed on the players' mobile wireless mobile wireless devices. These scores can also be displayed on a player's social networking site such as Facebook, so that other members of Facebook who do not participate in the game can see the scores.

Real-world maps can be stored on the server and sent to the mobile wireless devices at appropriate times based on the devices' GPS data. Alternatively, a third party map provider such as Google can perform the same task.

The mobile wireless devices have cameras that can be used to take pictures or video of players, targets, locations, and the general surrounding area. Pictures or video of players, targets, and locations can be analyzed by the game server to identify a target. Pictures or video of the general surrounding area can be used by the server to construct a three-dimensional representation of the battlefield.

A mobile wireless device can be set to display only players that are on the same team as the player using the mobile wireless device, only enemies, or both. The mobile wireless device can be set to display a map of the player's surrounding area generated by the server or a third party provider such as Google. The mobile wireless device can be set to display a three-dimensional representation of the battlefield computed by the server and transmitted to the mobile wireless device. The mobile wireless device can be set to display an aggregate or composite of the displays of the other mobile wireless devices.

This can be used to simulate a player acting as a commander in the game and to take action based on the aggregate display. A commander can use an artillery weapon to fire at targets based on the aggregate display.

The server can host or communicate with an in-game store that allows a player to buy, for example, better weapons with longer ranges, more ammunition, and armor. A player can buy these upgrades using actual money, a third party electronic currency provider such as PayPal, or virtual currency such as Facebook virtual currency system Credits. The game server can also award these upgrade options based on the player's experience point total.

Players can possess game-simulated armor. A player with armor is harder to hit than a player without armor. Different types of armor afford different levels of protection, corresponding to different levels of difficulty in being hit.

Third parties can purchase in-game advertising that can be used as a revenue-generating mechanism for a game-implementer.

The game can be played in a training mode in which players can learn to play the game and improve their skill. In this mode the game server does not track information about a player for purposes of scoring, such as attempted shots, captures, and being captured. Thus, a player can play in training mode without concern that the player's global scores will be negatively affected.

A player can be assigned a named rank indicating a rookie when the player first creates an account on the game server. As the player gains more experience points, the game server can assign a higher rank to the player.

The game can be played in territory-conquer mode. In this mode, a team of players have an objective of controlling a location on a map, for example, by capturing or excluding players of all other teams from the controlled territory. The players on the team can be awarded experience points based on the difficulty in conquering the location.

FIG. 1 shows what a player sees when first starting the application on a hand-held or other mobile wireless device, if the player does not have an account. The application is shown running on a mobile wireless device although other hardware platforms are possible. An account creation screen 100 contains an area for the player to enter a desired username 101 and a numeric personal identification number (PIN) 102. If the player does not want to create an account, the player presses the Cancel button 104. If the player does want to create an account, the player presses the Create button 103. The logo 105 for the application is displayed above the desired username field 101.

The top of the display shows icons related to the mobile wireless device that is hosting the application. A cell phone carrier identifier 107 is displayed between a signal strength indicator 106 and the type of data connection 108. The current time 111 is centered at the top of the display. The top right of the display shows a tracking icon 110 to indicate that the mobile wireless device's location services are active and a meter indicating the remaining battery power 109.

FIG. 2 shows that a player is entering a name and PIN to create an account. The bottom of the account creation screen 100 is overlaid with a keypad 203 for the player to type a PIN 202. The player can discard the typed PIN by pressing the PIN cancel button 200. As shown, the player has entered a username 201. The player presses the Create button 103 when ready to create the new account.

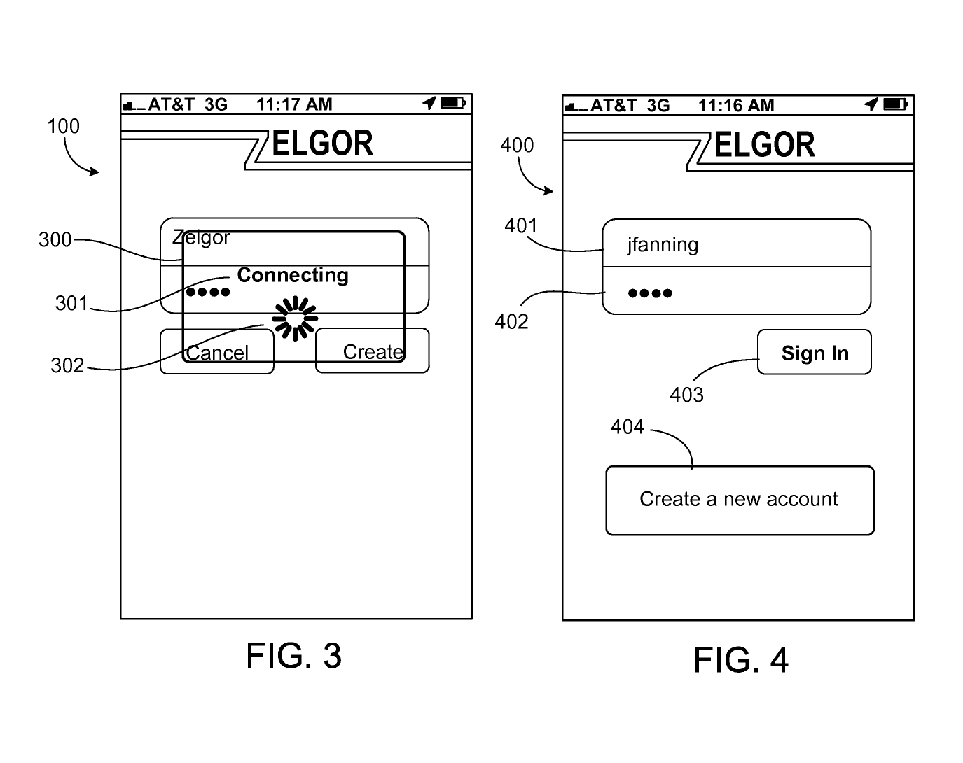

FIG. 3 shows that the application is connecting to a server to create the new account. A Connecting message window 300 is overlaid on top of the account creation screen 100. A Connecting message 301 is displayed along with an animated connection icon 302.

FIG. 4 shows what a player sees when launching the application, if an account has been created and the username and PIN have been entered. A login screen 400 contains an area for a player to enter a username 401 and PIN 402, both of which, in the illustrated example, have already been filled in. The player either entered them since launching the application, or the application by default keeps the last entries used. The player presses the Sign In button 403 to sign in to the game server. If the player does not have an account yet, the player can press the Create a new account button 404 to access the account creation screen 100.

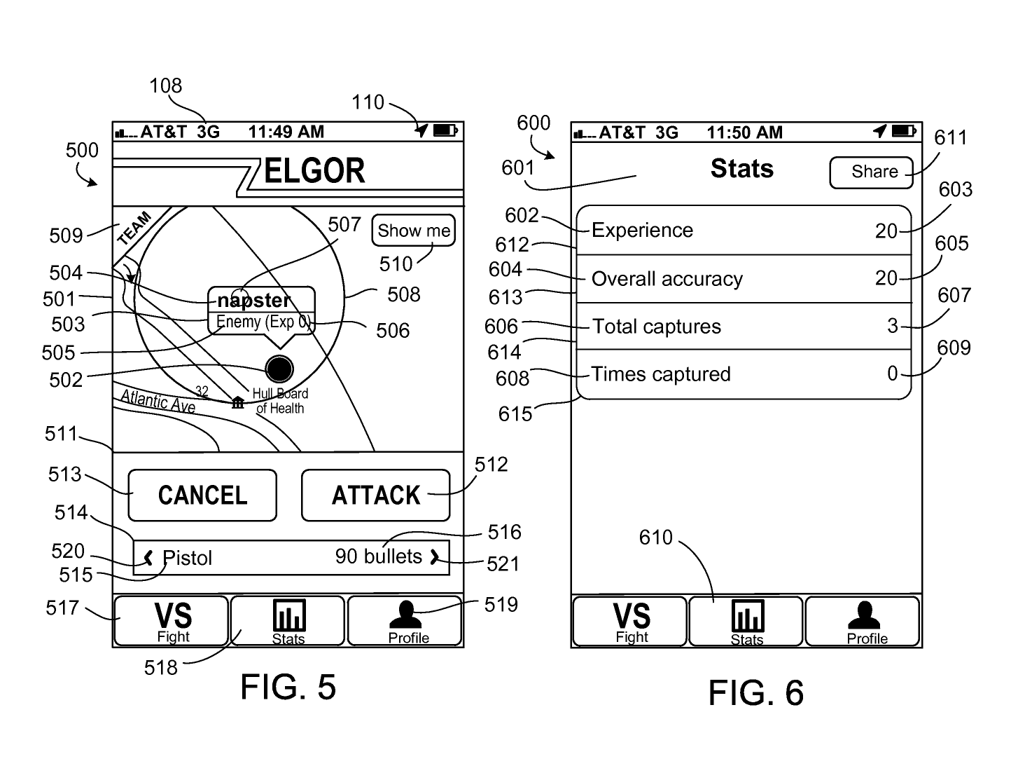

FIG. 5 shows what a player sees when playing the game and in Fight mode so that the player can attack. The Fight screen 500 displays a map 501 and a game-style representation of the player 507. The location of the player and the area surrounding the player are shown based on the location of the player's handheld device in the real world. The player's device's location is being tracked, by the GPS or other similar facility on the handheld device, as shown by the tracking icon 110 and is sent over the data network 108 to the game server 2201 in FIGS. 22-24.

The Fight screen 500 is shown with an attack control area 511 overlaid on the bottom portion of the map 501. The attack control area 511 was displayed as a result of the player touching the game-style representation of an enemy 502. The strength and accuracy of the GPS signal 508 is shown around the game-style representation of the player 507. A game-style representation of an enemy player 502 is displayed on the map 501 with a status display 503 indicating the enemy's name 504, status as an Enemy 505, and how many experience points 506 the enemy has. Experience points are awarded and stored on the server each time a player hits an enemy. The more experience points an enemy has when he is hit, the more experience points the shooter receives. A colored Team indicator 509 shows that the player is on the team of that color. If the player wants to center the map more closely on the player's position, the player presses the Show me button 510. This is useful if the player scrolled the map so that the player was no longer visible.

When the player is ready to attack another player, the player presses the Attack button 512. If the player decides he does not want to attack, or wants to get rid of the Attack screen 511, the player presses the Cancel button 513. An armament display area 514 shows the weapon currently being used 515 and the amount and type of ammunition 516 the weapon 515 is armed with. A weapon scroll bar 520 can be pressed to change weapons 515. An ammunition scroll bar 521 can be used to change ammunition 516. A Fight button 517 is illuminated to show that the game is in Fight mode. A Stats button 518 or a Profile button 519 can be pressed to go to other screens and modes.

FIG. 6 shows a game statistics screen where a player can view her current game-related statistics as tracked by the game server. The Stats screen 600 displays a Stats label 601 at the top center. Below that are areas that display the different statistics and their values.

The Experience display area 612 contains an Experience label 602 and a current Experience value 603. This value is based on how many times the player has hit an enemy. The more experience the enemy has when hit, the more experience points the player receives. Experience points are tracked by the game server.

The Overall accuracy display area 613 contains an Overall accuracy label 604 and a current Overall accuracy value 605. The game server computes the current Overall accuracy value 605 by dividing the player's total number of successful attacks by the total number of attacks and multiplying the result by one-hundred.

The Total captures display area 614 contains a Total Captures label 606 and a current Total captures value 607. The current Total captures value 607 corresponds to the number of times the player has captured another player. The Times captured display area 615, contains a Times captured label 608 and a current Times captured value 609. The current Times captured value 609 corresponds to the number of times the player has been captured by an enemy.

The illuminated Stats button 610 shows that the application is in Stats mode. If the player wants to post the statistics to a social network site such as Facebook, the player can press the Share button 611. Pressing the Share button 611 will enable the selection of one or more social networking sites by the player. The player's statistics and game achievements will be transmitted to the selected social networking sites to be displayed on the player's profile upon authentication by the social networking site.

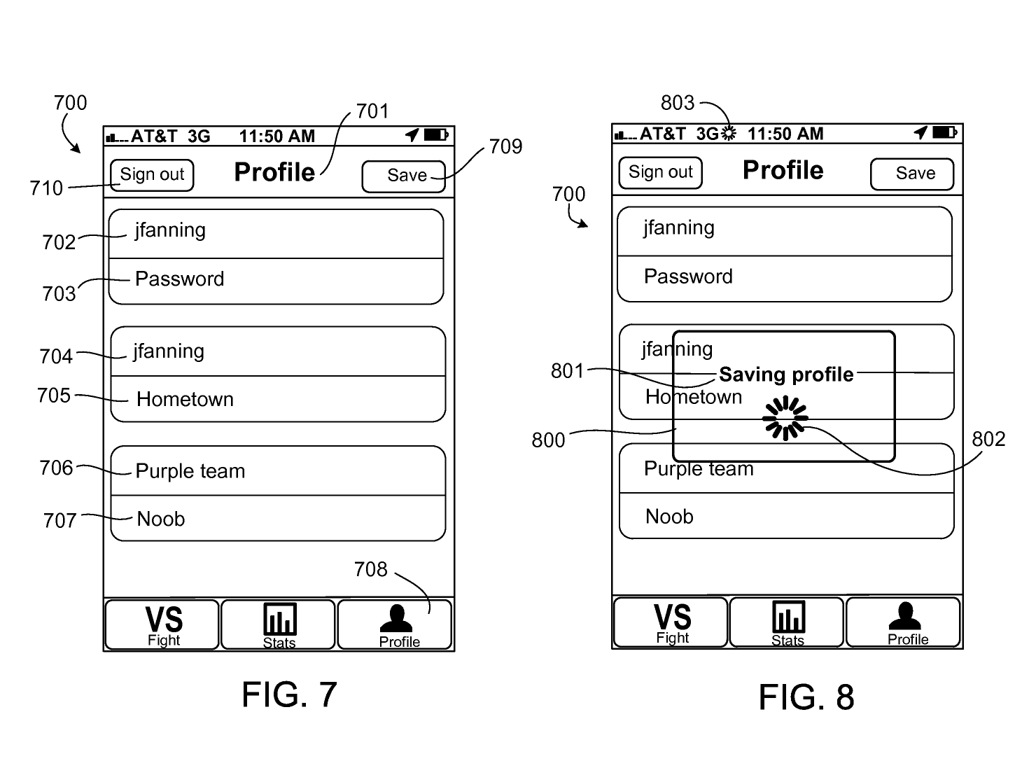

FIG. 7 shows a profile screen where a player can view and edit the player's profile information relating to the game. The Profile screen 700 contains a Profile label 701 at the top center. There is an area for the player to view the player's username 702 and change the player's password 703. There is an area for the player to view and edit the name visible to other players 704 and an area to view and edit an optional Hometown 705. There is an area to view the player's team 706 and an area to view and edit the player's team role 707. The player's team is randomly assigned by the game server and can only be changed if a player is captured. The player's team role 707 is set to “Noob” by default, which means a rookie; a “newbie.” The illuminated Profile button 708 shows that the application is in Profile mode. After the player had edited any desired information, the player can save the information to the server by pressing the Save profile button 709. The player can sign out of the game by pressing the Sign out button 710.

FIG. 8 shows what a player sees while the game saves the profile information. A Saving profile window 800 is overlaid on top of the Profile screen 700. The Saving profile window 800 contains a Saving profile message 801 and an animated icon 802 showing that the profile is being saved. An animated network activity icon 803 at the top of the device display shows that the device is communicating with the server.

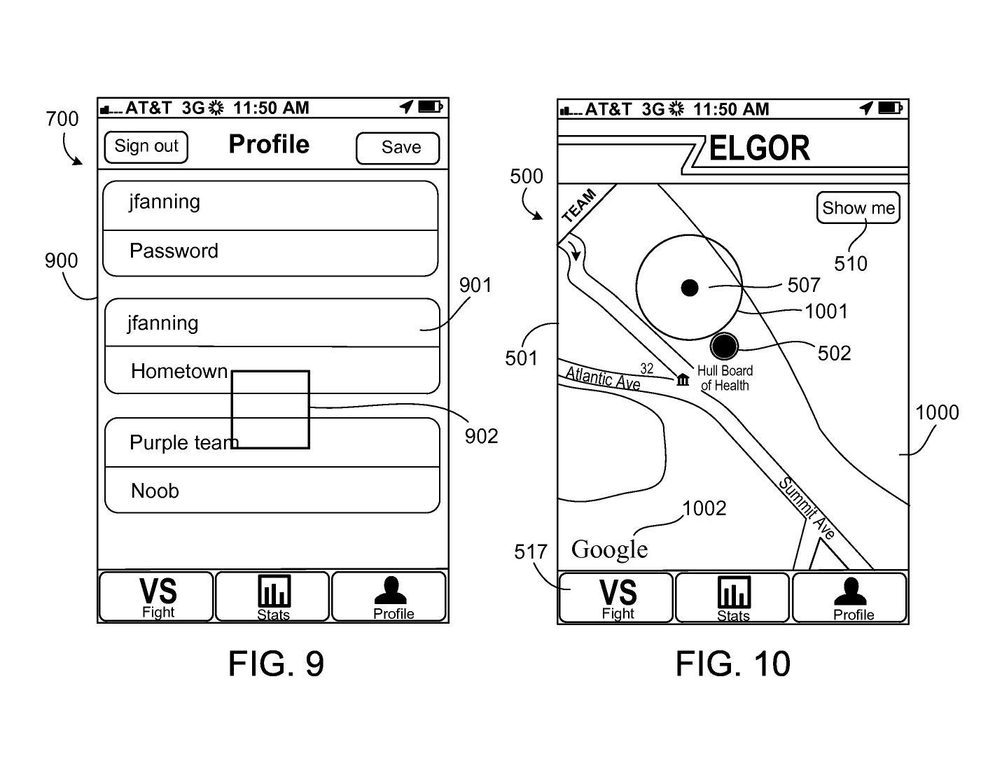

FIG. 9 shows what a player sees after the profile information has been saved. A Saved screen 900 is overlaid on a portion of the Profile screen 700. The Saved screen contains a Saved message 901 and a small graphic 902 to indicate that the player's information has been saved on the server.

FIG. 10 shows what a player sees when she returns to Fight mode. The illuminated Fight button 517 indicates the mode that the screen is in. The Fight screen 500 does not have the attack control area displayed and thus shows the map 501 with an expanded map view 1000. The service provider 1002 for the map data is displayed. The player position 507 and an enemy player 502 are shown near one another. Here, the strength and accuracy of the GPS signal 1001 is shown around the player's position 507 as a smaller diameter circle as compared with the GPS strength and accuracy signal indicator 508 in FIG. 5. The smaller diameter indicates a more accurate GPS fix on the mobile device's location. The player can press the Show me button 510 to center the map 501 more closely on the player's position 507.

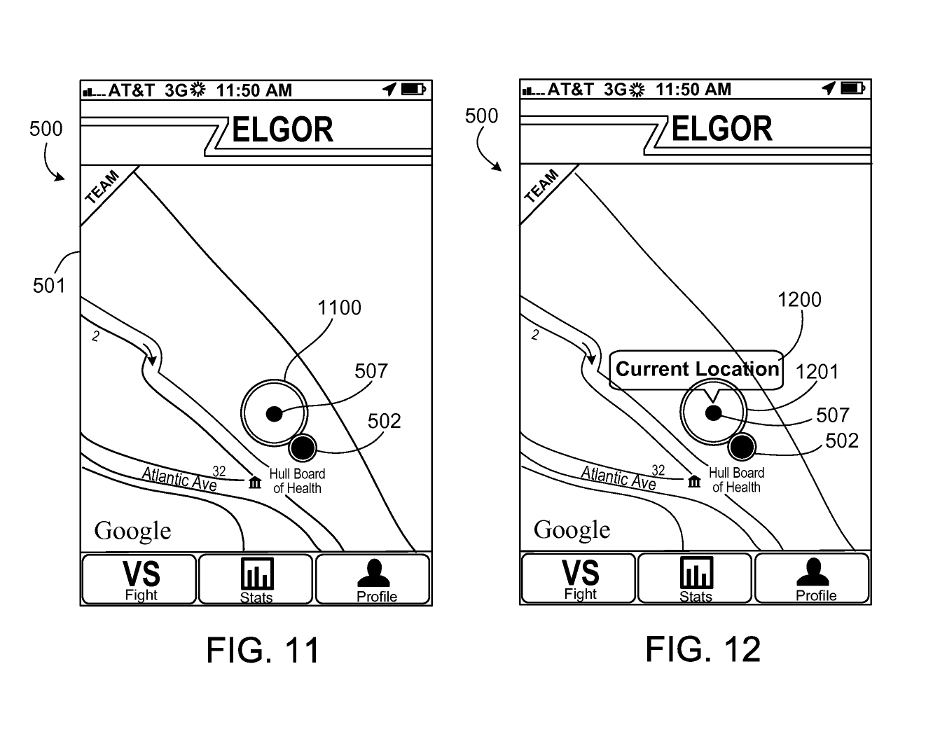

FIG. 11 shows the result of the player pressing the Show me button to center the map more closely on the player's position. The Fight screen 500 shows the player's position 507 closer to the center of the map 501. An enemy 502 is near the player. Here, the strength and accuracy of the GPS signal 1100 is shown around the player's position 507 at an even smaller diameter and with concentric circles. The smaller diameter indicates an even more accurate GPS location fix than the strength and accuracy of the GPS signal 1001 in FIG. 10. The concentric circles indicate a GPS lock from multiple GPS satellites.

FIG. 12 shows how the player finds out the name of the player's current location. On the Fight screen 500, the player can tap on the player's position 507 to bring up a display naming the current location 1200. The strength and accuracy of the GPS signal 1201 displayed around the player 507 has changed again. This indicates animation of the inner part of the concentric circles as a visual cue to the player of a strong, accurate, and multi-satellite GPS lock. An enemy 502 is near the player.

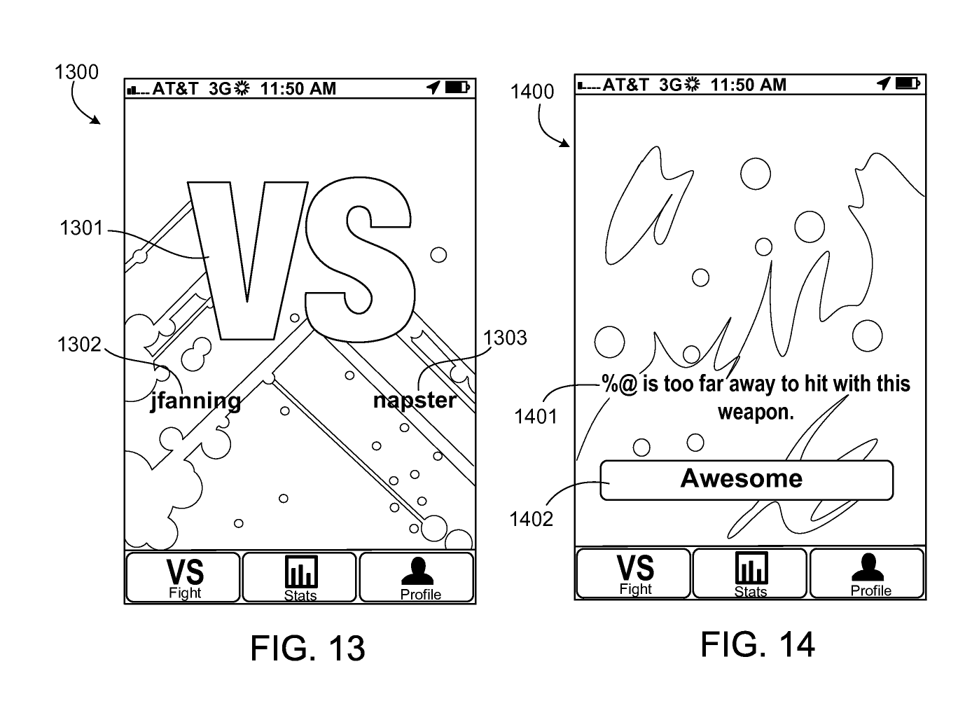

FIG. 13 shows a screen indicating that two players are battling in the game. This screen appears as the result of a player hitting the attack button 512 in FIG. 5 when an enemy player is in range of the player's weapon. The VS (short-hand for “versus”) battle screen 1300 displays a large VS graphic 1301, along with the player's name 1302 and the name of the enemy 1303. The VS battle screen 1300 is displayed on the player's when an attack has been initiated by that player against an enemy. The VS battle screen is not displayed on the target enemy's screen.

FIG. 14 shows a screen that is the result of the player being too far away from the enemy to hit him with the player's current weapon. An attack-out-of-range screen 1400 displays a message 1401 indicating that the player is too far away to hit the enemy with the player's current weapon. The attack-out-of-range screen 1400 contains an acknowledgment button 1402 that the player presses when ready to attack again.

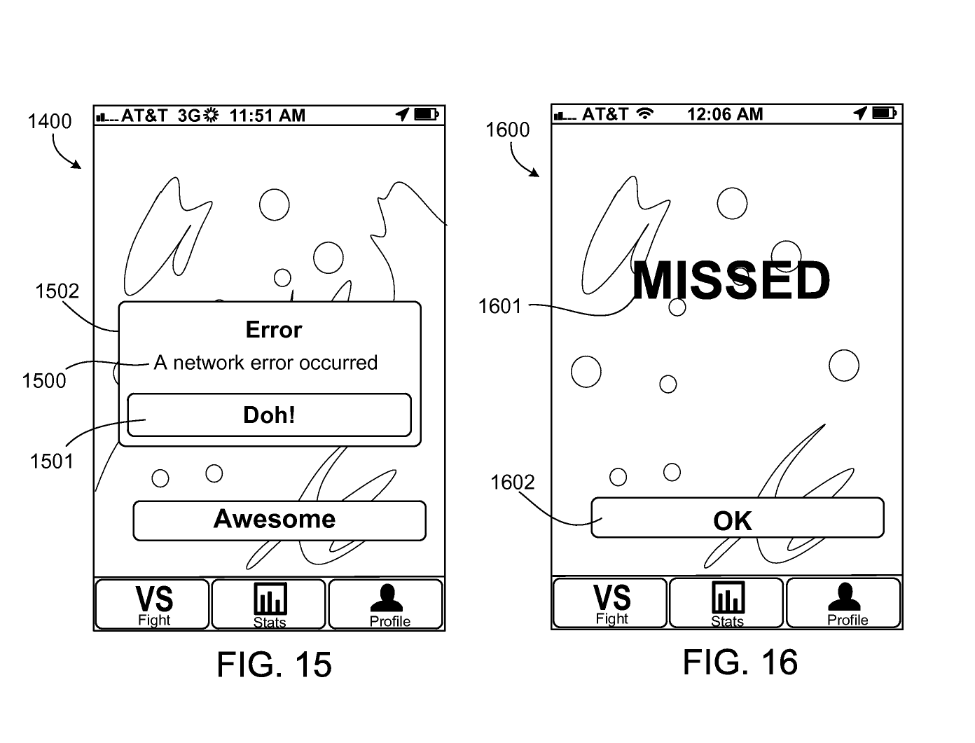

FIG. 15 shows the result of a network error occurring after hitting the acknowledge button. A network error screen 1502 is overlaid on the attack-out-of-range screen 1400. The network error screen 1502 contains a message 1500 indicating that a network error has occurred, along with a network error acknowledgement button 1501.

FIG. 16 shows a screen that is the result of a failed attack by the player. A failed-attack screen 1600 contains a large MISSED message 1601 and a missed-attack acknowledgment button 1602. The chance of success of an attack is based on a comparison of the shooter and target's experience levels, modified by a randomization factor. A target that has a greater experience level as compared to a shooter will be harder to hit.

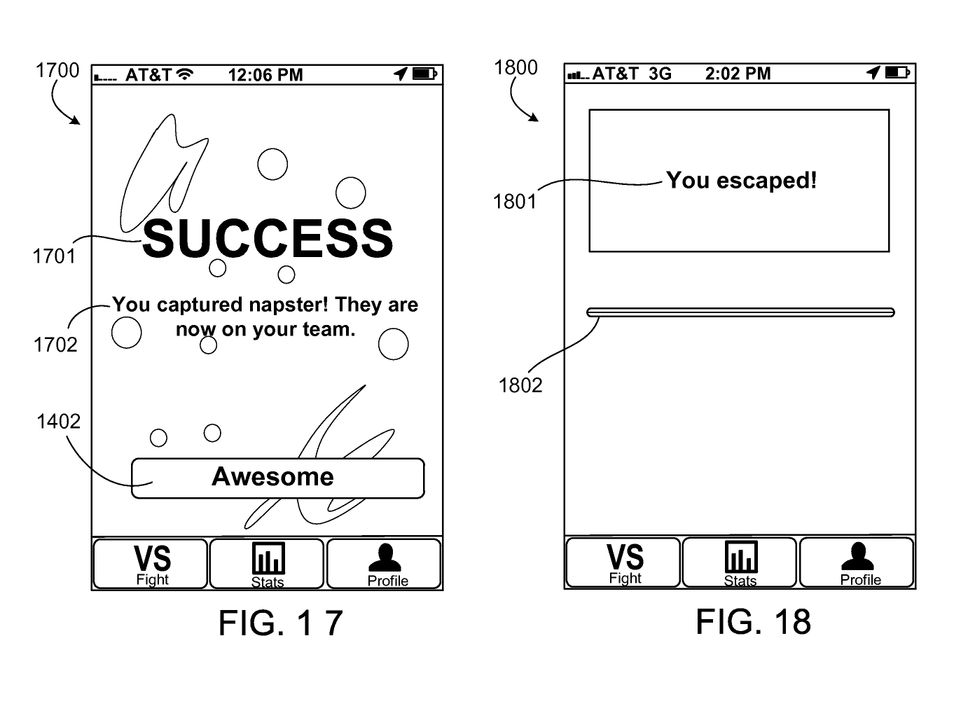

FIG. 17 shows a screen that is the result of a successful attack by the player. A successful-attack screen 1700 contains a large SUCCESS message 1701 and a message indicating which enemy was captured and that the enemy is now on the attacking player's team 1702. The player can press the successful-attack acknowledgement button 1402 when ready to continue.

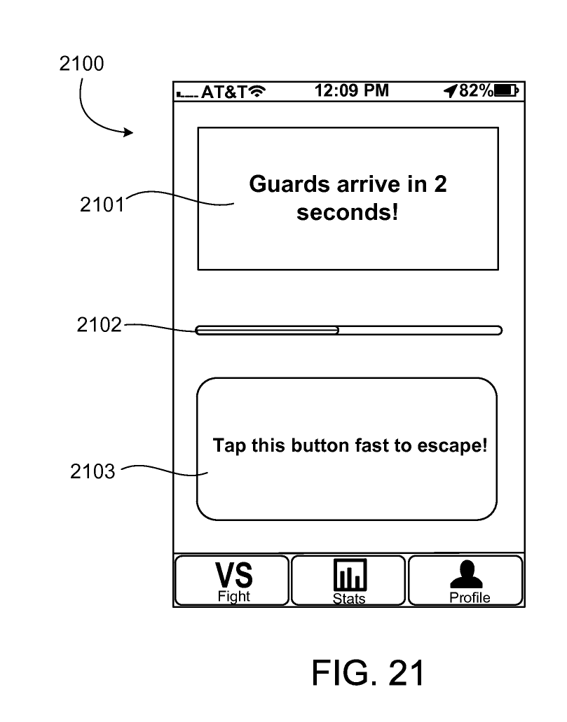

FIG. 21 shows a screen that a captured player sees when the player is initially captured. A guards-arriving screen 2100 shows a message 2101 that the guards are arriving within a timeframe, here two seconds. The guards do not actually exist but are mentioned in the message 2101 to make the game seem more realistic to the players. The captured player can try to escape by repeatedly tapping the escape button 2103. A progress bar 2102 fills in from left to right. The objective is to tap the escape button 2103 quickly and repeatedly to fill the progress bar 2102 before the timeframe in the message 2101 elapses. Each tap fills a portion of the progress bar 2012. The more experience points the capturing player has compared to the captured player, the less time the captured player will have to escape.

FIG. 18 shows a screen that a captured player sees if the player escapes. An escape screen 1800 displays a “You escaped!” message 1801. A filled progress bar 1802 indicates that the player filled the bar within the allotted timeframe by repeatedly tapping the escape button 2103 in FIG. 21.

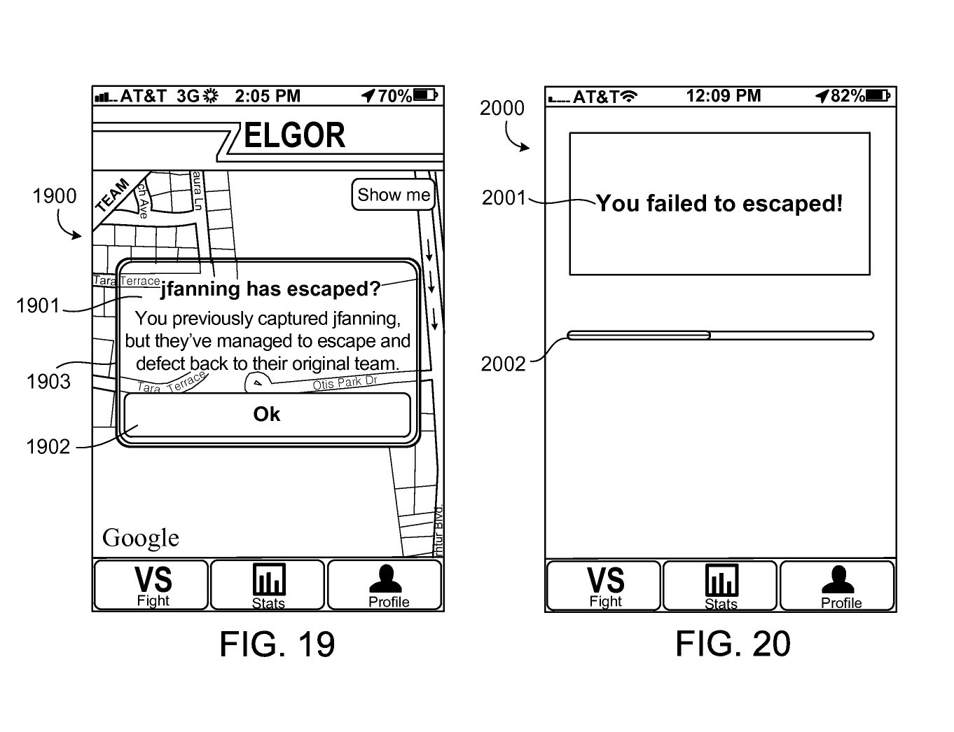

FIG. 19 shows a screen that a player sees when a previously captured enemy escapes and defects back to his original team. When an enemy is captured, the enemy becomes part of the attacking player's team. When an enemy escapes, the enemy becomes part of the enemy's old team. A previously-captured screen 1900 displays a previously captured message box 1903 with a message about which enemy escaped 1901 along with a previously-captured acknowledgment button 1902.

FIG. 20 shows a screen that a captured player sees if the player fails to escape. A failed-to-escape screen 2000 displays a “You failed to escape!” message 1801 and a partially filled progress bar 2002 indicating that the timeframe elapsed before the captured player could tap the escape button 2103 in FIG. 21 enough times to fill the progress bar 2002.

FIG. 22 shows the basic architecture of the system that implements the game. An architecture diagram 2200 contains blocks and connections that denote a computer-based system. A server 2201 contains, but is not limited to, the following modules: maps 2202, a combat engine 2204, and a store 2206.

Map data are communicated to the server 2201 from the maps module 2202 through the map-server connection 2203. Maps are used to locate players, objects, and locations in the real world. Maps are sent to mobile wireless devices so that players can see where players are located in the real world.

The combat engine 2204 performs various comparisons, described next, and communicates with the server 2201 via the combat engine-server connection 2205. The combat engine 2204 compares various factors 2208 to determine if an attack is successful: the proximity of a target to a shooter 2209 based on position information 2210 from the player's devices' position 2224; targeting information 2237 based on the shooter's mobile wireless device selection 2236 and orientation 2211; the trajectory 2212 of the shooter's fired ammunition based on projectile physics 2213 plus the relative motion of the shooter 2215 and the target 2214; and, the effect of the target's armor 2216, if any, against the shooter's weapon 2238. Other comparison factors 2217 may be used by the combat engine 2204.

The store 2206 communicates with the server 2201 through the store-server connection 2207. The store 2206 allows the player to purchase a) in-game upgrades to more powerful weapons with longer ranges, b) more ammunition, and c) armor. A player having armor is harder to hit than a player without armor. Players can

The server 2201 sends and receives 2218 data to the players' devices 2221 through a wireless medium 2219. The players' mobile wireless devices 2221 have connections to the wireless medium 2220. The mobile wireless device 2221 for Player 1, a Shooter 2222, tracks multiple data, including, but not limited to, the following: the mobile wireless device's 2221 position 2224 using a Global Positioning System (GPS) 2223; the mobile wireless device's 2221 orientation 2226 using a compass 2225; the mobile wireless device's 2221 speed 2227 and direction 2228 using the GPS 2223 and accelerometers 2230; the time when a shot was fired 2231 using a clock 2232; the points accumulated 2233 by the Shooter 2222; and, a selection 2234 based on a point indicated on the map 2235. The mobile wireless device 2221 for Player 2, the Target, tracks the same data as the Shooter's 2222 mobile wireless device 2221, except for a selection 2234.

FIG. 23 shows a three-dimensional representation of how a mobile wireless device's camera can be used for targeting. A three-dimensional representation 2300 shows the interaction between a shooter's mobile wireless device 2302, a target's mobile wireless device 2303, and a server 2201, when a camera is used for targeting.

The shooter's mobile wireless device 2302 has a live data connection 2304 to a wireless medium 2219 which has a connection 2218 to the server 2201. The target's mobile wireless device 2303 also has a live connection 2305 to the wireless medium 2319.

The shooter's mobile wireless device 2302 is shown casting a shadow 2315 on the playing field 2301 to indicate that the shooter's mobile wireless device 2302 is not touching the playing field 2301. Likewise, the target's mobile wireless device 2303 is shown casting a shadow 2316 on the playing field 2301 to indicate that the target's mobile wireless device 2303 is not touching the playing field 2301.

Also present on the playing field 2301 is a hole 2317. The target's mobile wireless device 2303 is shown with a rear-facing view exposing a camera 2306, which is also present on the back of the shooter's mobile wireless device 2302 but not shown in this figure. The display 2307 on the shooter's mobile wireless device 2302 is showing the output of the camera, located on the back of the shooter's mobile wireless device 2302. The display 2307 is overlaid with a targeting reticle 2310 and a fire button 2312. Also shown on the display 2307 of the shooter's mobile wireless device in the image from the camera is the playing field 2311. The targeting reticle 2310 is shown placed on the target's mobile wireless device's picture 2308 corresponding with the target's mobile wireless device 2303. Similarly visible in the shooter's mobile wireless device's display 2307 is a picture of the target's mobile wireless device's camera 2309, corresponding to the rear-facing camera 2306 on the target's mobile wireless device 2303.

If the shooter presses the fire button 2312 the server 2201 will determine if a hit should be registered for the shooter based on the server's 2201 internal state, the information from the shooter's mobile wireless device's 2302 camera, the location of the targeting reticle 2310 on the shooter's mobile wireless device's display 2307, and the location of the target's mobile wireless device 2303, which is the target in this example. The server 2201 can use additional information and calculations to perform the hit determination, such as relative experience point levels and a randomization factor. The shooter's mobile wireless device 2302 also has a speaker 2314 for audio output and a hardware button 2313 for out-of-application interaction such as switching applications.

FIG. 24 shows a three-dimensional representation of how the game server can use a map for indirect fire, simulating artillery, when a target is blocked by a barrier. A three-dimensional representation 2400 shows the interaction between a shooter's mobile wireless device 2302, a target's mobile wireless device 2303, and a server 2201 when a barrier 2401 is blocking line-of-sight from the shooter's mobile wireless device 2302 and the target's mobile wireless device 2303. The display 2307 on the shooter's mobile wireless device 2302 is showing a top-down map display 2405 that is generated by the server 2201. The top-down map display 2405 contains a top-down view of the target 2403, a label for the target 2402, a top-down view of the barrier 2404 and a top-down view 2407 of a hole 2317.

The server 2201 records the location of the shooter's mobile wireless device 2302, the target's mobile wireless device 2303 and the barrier 2401. Location information may or may not be displayed on the display 2307 of the shooter's mobile wireless device 2302. The shooter can perform targeting by touching the display 2307 of the shooter's mobile wireless device 2302 at a location on the display 2307 corresponding to a location on the playing field 2301 that the shooter wishes to fire at with a game weapon that can arc and cause indirect fire such as artillery. The server determines the result of the shot based on the tracked locations of the shooter's mobile wireless device 2302 and the target's mobile wireless device 2303. The server contains information on the height of the barrier 2401, enabling the server to determine how much arc is needed on the artillery's trajectory to still hit the target's mobile wireless device 2303.

In some examples, the game can be used as a social-media-game-based ice breaker. In social situations, for example at a bar or in a networking event, some people have approach anxiety that reduces their willingness to approach strangers to meet them. People can use their mobile wireless devices to locate people near them and connect with them in a social network that reduces their approach anxiety. In the system described here, a player can shoot someone, then you can look at his profile, find out in-depth information about him, and use the facilities of the game to locate, introduce, and communicate in a unobtrusive low-risk way.

In some implementations, one of the weapons a player can choose to use is a knife. (A player can start with a knife as one of her initial weapons.) The knife has a very short range and does not require ammunition. In that sense, the player who uses it might not be called a shooter but rather an attacker.

In some examples, non-mobile, non-wireless devices could be used to play the game.

Other embodiments are within the scope of the following claims.

What is claimed is:

1. A device-based method comprising:
at a server, comparing (a) a geographic position of a mobile wireless device held by a person who is a target in a game with (b) an indication of a targeted position related to the target as shown on a mobile wireless device being held by a person who is an attacker in the game, and
depending on a result of the comparing of the geographic position and the indication, recording that the attacker has hit the target in the game.

2. The method of claim 1 in which the indication comprises a reticle.

3. The method of claim 1 in which the geographic position is provided to the server wirelessly.

4. The method of claim 1 in which the indication is provided to the server wirelessly.

5. The method of claim 1 in which the attacker and the target are members of different teams.

6. The method of claim 1 in which recording that the attacker has hit the target comprises designating that the target has been captured by the attacker.

7. The method of claim 6 in which designating that the target is been captured by the attacker comprises designating that the target has become a member of the attacker's team.

8. The method of claim 6 in which after being captured by the attacker, the target is enabled to escape.

9. The method of claim 8 in which enabling the target to escape comprises providing an interactive feature of the mobile wireless device of the target.

10. The method of claim 9 in which the interactive feature comprises designating an area on a display of the target's mobile wireless device that is be touched repeatedly.

11. The method of claim 10, in which the target is deemed to have escaped if the target touches the designated area of the target's mobile wireless device enough times within a specified timeframe.

12. The method of claim 1 also comprising enabling each of the people and other people to buy virtual items for use in the game.

13. The method of claim 12 in which the virtual items comprise weapons, ammunition, and armor.

14. A device-based method comprising:
at a server, determining, from an image captured by a camera of a mobile wireless device of surroundings of the mobile wireless device, whether a target of an attacker who is holding the mobile wireless device is present in the image, and
if so, notifying the mobile wireless device held by the attacker.

15. The method of claim 14 in which the determining comprises image recognition of the image and a comparison of the recognized image to a known image of the target.

16. The method of claim 15 in which the image recognition comprises facial recognition.

17. The method of claim 15 in which the image recognition comprises object recognition.

18. The method of claim 15 in which the determining is done at the mobile wireless device.

19. A device based method, comprising:
at a server, constructing a three-dimensional representation of a battlefield of a game, based on an image captured by a camera of a mobile wireless device of surroundings of the mobile wireless device.

20. The method of claim 19 in which constructing a three-dimensional representation of a battlefield of a game is also based on images captured by the cameras of multiple handheld devices of surroundings of the handheld devices.

21. The method of claim 1 in which the geographic position and the targeted position are displayed on a map that is served to the mobile wireless device.

22. The method of claim 21 in which the map comprises a street map provided by a third party.

23. The method of claim 1 also comprising displaying on the device of at least one of the people indications of the locations of other players.

24. The method of claim 23 in which the displaying comprises displaying only friendly players or only enemy players.

25. The method of claim 21 in which the map comprises a map of a battlefield.

26. A device-based method comprising,
from a server, providing information wirelessly to mobile wireless devices being used in an action game by players belonging to a team for presentation to the respective players on displays of the devices, the presentations to each of the different players being configured specially for that player, the information that is provided to a particular one of the mobile wireless devices being configured for presentation to one of the players of a composite of the presentations to the other players of the team.

27. The method of claim 26 in which the one of the players is serving as a commander of the team and the presentation is in a commander mode on the mobile wireless device of that player.

28. The method of claim 1 in which the attacker is enabled to use virtual artillery as a weapon on making the hit.

29. The method of claim 28 in which the server determines trajectories of shots fired from the virtual artillery.

30. The method of claim 1 comprising enabling the target to use virtual armor to resist an attack by the attacker.

31. The method of claim 1 in which the server maintains a global scoreboard for scores achieved by players and teams in the game.

32. The method of claim 1 comprising enabling a participant in the game to buy upgrades.

33. The method of claim 1 comprising displaying in-game advertising to participants in the game.

34. The method of claim 1 comprising displaying performance of players in the game on social-network online sites.

35. The method of claim 1 comprising attributing experience points to the attacker, the experience points being based at least in part on an experience level of the target.

36. The method of claim 1 comprising enabling a training mode of the game in which no scores are kept.

37. The method of claim 1 comprising maintaining on the server rankings for players, and advancing players in rank based on their performances.

38. The method of claim 1 comprising enabling a player or team to conquer a territory by hitting or excluding players of other teams from the territory.

39. The method of claim 1 in which the server manages the game so that a target that has more game experience than an attacker is harder for the attacker to hit and can escape more easily.

40. The method of claim 1 in which the server manages the game so that the more experience points a target has, the more experience points an attacker receives for a successful hit.

41. The method of claim 1 comprising providing a voice or text private communication channel between players.

42. The method of claim 41 in which a player can instruct another player through the communication channel.

43. The method of claim 1 in which recording of the hit comprises recording the hit if the geographic position and the indication are close enough to a shot's path to be a hit.

44. The method of claim 14 in which the target is verified to be present based on location information on the server.

45. The method of claim 1 in which participants in the game wear a visible token that identifies them or a team to which they belong.

46. The method of claim 1 also comprising enabling direct communication between the mobile wireless devices using wireless networking, ad-hoc networks on 802.11a/b/g/n, or bluetooth.”

47. The method of claim 46 in which the direct communication supplements, extends, or heals a main communication channel.

48. The method of claim 1 in which participants in the game are enabled to indicate a target by choosing a location on a map and hitting it with a shot that takes an interval of time to strike and affects a defined region of the target, thus simulating indirect fire with an explosive.

49. The method of claim 1 in which a player in the game is enabled to buy, as part of the game, virtual versions of ransom, intelligence, medical insurance, or medical treatment.
